(19) United States
(12) Patent Application Publication
(10) Pub. No.: US 2023/0132157 A1
(43) Pub. Date: Apr. 27, 2023

(54) ANNULAR NUCLEAR FUEL ROD

(71) Applicant: Westinghouse Electric Company LLC, Cranberry Township, PA (US)

(72) Inventors: Luke C. OLSON, Columbia, SC (US); Kathryn E. METZGER, Columbia, SC (US); Edward J. LAHODA, Pittsburgh, PA (US); Elwyn ROBERTS, Lugoff, SC (US); Michael R. ICKES, West Homestead, PA (US); Paolo FERRONI, Pittsburgh, PA (US); Denise Adorno LOPES, Västerås (SE); Luke D. CZERNIAK, North Huntingdon, PA (US); Fausto FRANCESCHINI, Lerici (IT)

(73) Assignee: Westinghouse Electric Company LLC, Cranberry Township, PA (US)

(21) Appl. No.: 17/451,726

(22) Filed: Oct. 21, 2021

(51) Int. Cl. G21C 3/07; G21C 3/42; G21C 3/10; G21C 3/16

(52) U.S. Cl. CPC G21C 3/07; G21C 3/10; G21C 3/16; G21C 3/42

(57) ABSTRACT

Annular nuclear fuel rods are disclosed. The annular nuclear fuel rods include an outer cladding tube made of ceramic composite or cermet composite, an inner cladding tube made of ceramic composite or cermet composite, a nuclear fuel region located between the outer cladding tube and inner cladding tube, and an open channel for liquid coolant to flow.

### GOVERNMENT SUPPORT

This invention was made with government support under Contract No. NE-0008824. The government has certain rights in the invention.

### BACKGROUND

The invention relates generally to annular nuclear fuel rods comprising an inner and outer tube, more specifically to annular nuclear fuel rods comprising an inner and outer tube made of ceramic composite or cermet composite.

### SUMMARY

In various embodiments, an annular nuclear fuel rod is disclosed. The annular nuclear fuel rod includes an outer cladding tube made of ceramic composite or cermet composite, an inner cladding tube made of ceramic composite or cermet composite, a nuclear fuel region located between the outer cladding tube and inner cladding tube, and an open channel for liquid coolant to flow. The open channel extends through the inner cladding tube.

In various other embodiments, an annular nuclear fuel rod is disclosed. The annular nuclear fuel rod includes an outer cladding tube made of ceramic composite or cermet composite; an inner cladding tube made of cermet composite or cermet composite; a nuclear fuel region located between the outer cladding tube and inner cladding tube, wherein the nuclear fuel region comprises a nuclear cermet fuel in annular pellet form; and an open channel for liquid coolant to flow. The open channel extends through the inner cladding tube.

### BRIEF DESCRIPTION OF THE DRAWINGS

Various features of the embodiments described herein, together with advantages thereof, may be understood in accordance with the following description taken in conjunction with the accompanying drawings as follows:

FIG. 1 illustrates an annular nuclear fuel rod, according to at least one aspect of the present disclosure.

FIG. 2 illustrates an annular nuclear fuel rod, according to at least one aspect of the present disclosure.

Corresponding reference characters indicate corresponding parts throughout the several views. The exemplifications set out herein illustrate various embodiments of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the embodiments as described in the specification and illustrated in the accompanying drawings. Well-known operations, components, and elements have not been described in detail so as not to obscure the embodiments described in the specification. The reader will understand that the embodiments described and illustrated herein are non-limiting examples, and thus it can be appreciated that the specific structural and functional details disclosed herein may be representative and illustrative. Variations and changes thereto may be made without departing from the scope of the claims.

Nuclear fuel rods routinely comprise zirconium based cladding and uranium dioxide (UO₂) fuel. Zirconium based cladding and UO₂ fuel, however, can be limited in their energy density and operating power. For example, safety requirements limit the centerline temperature of UO₂ fuel to below the melting point of UO₂ and below specified cladding surface temperatures during transient and accidental conditions which induce higher than normal power levels.

It is therefore a goal of the present disclosure to provide annular nuclear fuel rods that provide increased energy density, a reduced centerline temperature of the fuel pellet allowing higher power levels, and nuclear fuel comprising greater than 5% enriched ²³⁵U.

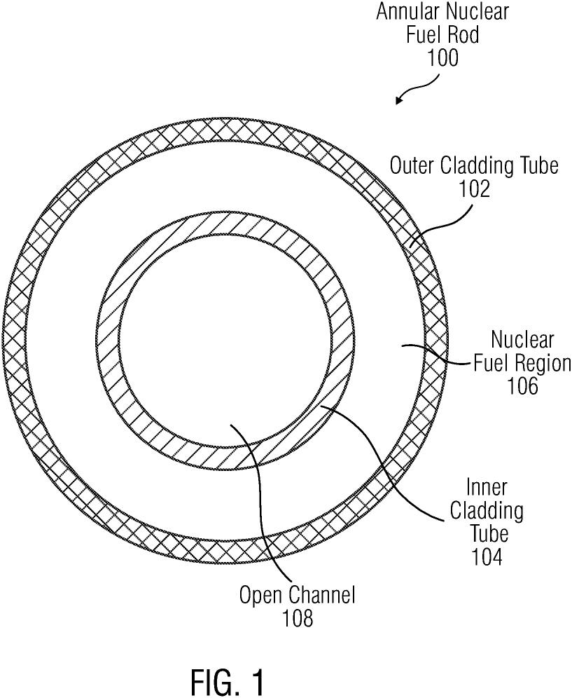

Referring now to FIG. 1, an annular nuclear fuel rod 100 is provided, according to at least one aspect of the present disclose. The annular nuclear fuel rod 100 can include an outer cladding tube 102, an inner cladding tube 104, a nuclear fuel region 106 located between the outer cladding tube 102 and the inner cladding tube 104, and an open channel 108. The open channel 108 can extend through the inner cladding tube 104. Liquid coolant can flow within the open channel 108. An increase in power density is possible because of additional heat transfer area per volume from the nuclear fuel region 106 to the liquid coolant within the open channel 108 that extends through the inner cladding tube 104 and the liquid coolant outside the outer cladding 102.

The outer cladding tube 102 can be made of ceramic composite or cermet composite. The inner cladding tube 104 can be made of ceramic composite or cermet composite. The outer cladding tube 102 and inner cladding tube 104 can be the same composite (i.e., ceramic/ceramic or cermet/cermet) or different composites (i.e., ceramic/cermet or cermet/ceramic).

The ceramic composite can comprise silicon carbide (SiC), aluminum oxide (Al₂O₃), boron carbide (BC), boron nitride (BN), carbon fiber (C), other ultra-high temperature ceramic matrix composites (UHTCMCs), technical ceramics such as: SiO₂, SiN, ZrO₂, SiAlON type ceramics, ZrB₂, HfB₂, TaSi₂, Si₃N₄, MoSi₂, ZrSi₂, (Hf, Zr, Ta)C, or combinations thereof.

The cermet composite can comprise a metal, such as zirconium (Zr), molybdenum (Mo), tungsten (W), vanadium (V), chromium (Cr), niobium (Nb), FeCrAl, FeCrAlY, or combinations thereof. The cermet composite further comprises one or more of the ceramics disclosed herein (i.e., SiC, Al₂O₃, BC, BN, C, ultra-high temperature ceramic matrix composites, or technical ceramics) or combinations of the ceramics.

Ceramic composite and cermet composite are used to provide oxidation resistance, superior strength at high temperatures (i.e., greater than 500° C., greater than 1000° C., or greater than 1500° C.), and eliminate many of the operating limitations (i.e., higher surface temperatures encountered in accidents and transients) and accidental concerns associated with zirconium-based cladding.

The nuclear fuel region 106 can comprise nuclear fuel in annular pellet form. The nuclear fuel in annular pellet form reduces the centerline temperature of the fuel pellet. The nuclear fuel in annular pellet form can be UO₂, uranium nitride (UN), uranium diboride (UB₂), uranium tetraboride (UB₄), and uranium carbide (UC). The nuclear fuel can be alone, in combination with another nuclear fuel, or in combination with an additive, such as an additive selected from the group consisting of Zr, Cr, Mo, ZrB₂, Cr₂O₃, Al₂O₃, and combinations thereof.

The nuclear fuel in annular pellet form can comprise greater than 5% enriched ²³⁵U. The nuclear fuel in annular pellet form can comprise at least 6% enriched ²³⁵U, at least 6.5% enriched ²³⁵U, at least 7% enriched ²³⁵U, at least 7.5% enriched ²³⁵U, at least 8% enriched ²³⁵U, at least 8.5% enriched ²³⁵U, at least 9% enriched ²³⁵U, at least 9.5% enriched ²³⁵U, at least 10% enriched ²³⁵U, at least 10.5% enriched ²³⁵U, at least 11% enriched ²³⁵U, at least 11.5% enriched ²³⁵U, at least 12% enriched ²³⁵U, at least 12.5% enriched ²³⁵U, at least 13% enriched ²³⁵U, at least 13.5% enriched ²³⁵U, at least 14% enriched ²³⁵U, at least 14.5% enriched ²³⁵U, at least 15% enriched ²³⁵U, at least 15.5% enriched ²³⁵U, at least 16% enriched ²³⁵U, at least 16.5% enriched ²³⁵U, at least 17% enriched ²³⁵U, at least 17.5% enriched ²³⁵U, at least 18% enriched ²³⁵U, at least 18.5% enriched ²³⁵U, at least 19% enriched ²³⁵U, at least 19.5% enriched ²³⁵U, or at least 20% enriched ²³⁵U.

The nuclear fuel in annular pellet form can comprise greater than 5% up to 6% enriched ²³⁵U, greater than 5% up to 6.5% enriched ²³⁵U, greater than 5% up to 7% enriched ²³⁵U, greater than 5% up to 7.5% enriched ²³⁵U, greater than 5% up to 8% enriched ²³⁵U, greater than 5% up to 8.5% enriched ²³⁵U, greater than 5% up to 9% enriched ²³⁵U, greater than 5% up to 9.5% enriched ²³⁵U, greater than 5% up to 10% enriched ²³⁵U, greater than 5% up to 10.5% enriched ²³⁵U, greater than 5% up to 11% enriched ²³⁵U, greater than 5% up to 11.5% enriched ²³⁵U, greater than 5% up to 12% enriched ²³⁵U, greater than 5% up to 12.5% enriched ²³⁵U, greater than 5% up to 13% enriched ²³⁵U, greater than 5% up to 13.5% enriched ²³⁵U, greater than 5% up to 14% enriched ²³⁵U, greater than 5% up to 14.5% enriched ²³⁵U, greater than 5% up to 15% enriched ²³⁵U, greater than 5% up to 15.5% enriched ²³⁵U, greater than 5% up to 16% enriched ²³⁵U, greater than 5% up to 16.5% enriched ²³⁵U, greater than 5% up to 17% enriched ²³⁵U, greater than 5% up to 17.5% enriched ²³⁵U, greater than 5% up to 18% enriched ²³⁵U, greater than 5% up to 18.5% enriched ²³⁵U, greater than 5% up to 19% enriched ²³⁵U, greater than 5% up to 19.5% enriched ²³⁵U, and greater than 5% up to 20% enriched ²³⁵U.

The nuclear fuel in annular pellet form can comprise at least 10% up to 20% enriched ²³⁵U, at least 10.5% up to 20% enriched ²³⁵U, at least 11% up to 20% enriched ²³⁵U, at least 11.5% up to 20% enriched ²³⁵U, at least 12% up to 20% enriched ²³⁵U, at least 12.5% up to 20% enriched ²³⁵U, at least 13% up to 20% enriched ²³⁵U, at least 13.5% up to 20% enriched ²³⁵U, at least 14% up to 20% enriched ²³⁵U, at least 14.5% up to 20% enriched ²³⁵U, at least 15% up to 20% enriched ²³⁵U, at least 15.5% up to 20% enriched ²³⁵U, at least 16% up to 20% enriched ²³⁵U, at least 16.5% up to 20% enriched ²³⁵U, at least 17% up to 20% enriched ²³⁵U, at least 17.5% up to 20% enriched ²³⁵U, at least 18% up to 20% enriched ²³⁵U, at least 18.5% up to 20% enriched ²³⁵U, at least 19% up to 20% enriched ²³⁵U, and at least 19.5% up to 20% enriched ²³⁵U.

The nuclear fuel region 106 can comprise a nuclear cermet fuel in annular pellet form. The nuclear cermet fuel in annular pellet form reduces the centerline temperature of the fuel pellet. The nuclear cermet fuel in annular pellet form can comprise an inert metal matrix (i.e., Mo, Zr, stainless steel, Al, W, Ta, Nb, FeCrAl, FeCrAlY) and any nuclear fuel disclosed herein (i.e., UO₂, UN, UB₂, UB₄, UC. The nuclear fuel can be alone, in combination with another nuclear fuel, or in combination with an additive, such as an additive selected from the group consisting of Zr, Cr, Mo, ZrB₂, Cr₂O₃, Al₂O₃, and combinations thereof). The inert metal matrix provides high heat transport away from the fuel particles.

The nuclear cermet fuel in annular pellet form can comprise greater than 5% enriched ²³⁵U. The nuclear cermet fuel in annular pellet form can comprise at least 6% enriched ²³⁵U, at least 6.5% enriched ²³⁵U, at least 7% enriched ²³⁵U, at least 7.5% enriched ²³⁵U, at least 8% enriched ²³⁵U, at least 8.5% enriched ²³⁵U, at least 9% enriched ²³⁵U, at least 9.5% enriched ²³⁵U, at least 10% enriched ²³⁵U, at least 10.5% enriched ²³⁵U, at least 11% enriched ²³⁵U, at least 11.5% enriched ²³⁵U, at least 12% enriched ²³⁵U, at least 12.5% enriched ²³⁵U, at least 13% enriched ²³⁵U, at least 13.5% enriched ²³⁵U, at least 14% enriched ²³⁵U, at least 14.5% enriched ²³⁵U, at least 15% enriched ²³⁵U, at least 15.5% enriched ²³⁵U, at least 16% enriched ²³⁵U, at least 16.5% enriched ²³⁵U, at least 17% enriched ²³⁵U, at least 17.5% enriched ²³⁵U, at least 18% enriched ²³⁵U, at least 18.5% enriched ²³⁵U, at least 19% enriched ²³⁵U, at least 19.5% enriched ²³⁵U, or at least 20% enriched ²³⁵U.

The nuclear cermet fuel in annular pellet form can comprise greater than 5% up to 6% enriched ²³⁵U, greater than 5% up to 6.5% enriched ²³⁵U, greater than 5% up to 7% enriched ²³⁵U, greater than 5% up to 7.5% enriched ²³⁵U, greater than 5% up to 8% enriched ²³⁵U, greater than 5% up to 8.5% enriched ²³⁵U, greater than 5% up to 9% enriched ²³⁵U, greater than 5% up to 9.5% enriched ²³⁵U, greater than 5% up to 10% enriched ²³⁵U, greater than 5% up to 10.5% enriched ²³⁵U, greater than 5% up to 11% enriched ²³⁵U, greater than 5% up to 11.5% enriched ²³⁵U, greater than 5% up to 12% enriched ²³⁵U, greater than 5% up to 12.5% enriched ²³⁵U, greater than 5% up to 13% enriched ²³⁵U, greater than 5% up to 13.5% enriched ²³⁵U, greater than 5% up to 14% enriched ²³⁵U, greater than 5% up to 14.5% enriched ²³⁵U, greater than 5% up to 15% enriched ²³⁵U, greater than 5% up to 15.5% enriched ²³⁵U, greater than 5% up to 16% enriched ²³⁵U, greater than 5% up to 16.5% enriched ²³⁵U, greater than 5% up to 17% enriched ²³⁵U, greater than 5% up to 17.5% enriched ²³⁵U, greater than 5% up to 18% enriched ²³⁵U, greater than 5% up to 18.5% enriched ²³⁵U, greater than 5% up to 19% enriched ²³⁵U, greater than 5% up to 19.5% enriched ²³⁵U, and greater than 5% up to 20% enriched ²³⁵U.

The nuclear cermet fuel in annular pellet form can comprise at least 10% up to 20% enriched ²³⁵U, at least 10.5% up to 20% enriched ²³⁵U, at least 11% up to 20% enriched ²³⁵U, at least 11.5% up to 20% enriched ²³⁵U, at least 12% up to 20% enriched ²³⁵U, at least 12.5% up to 20% enriched ²³⁵U, at least 13% up to 20% enriched ²³⁵U, at least 13.5% up to 20% enriched ²³⁵U, at least 14% up to 20% enriched ²³⁵U, at least 14.5% up to 20% enriched ²³⁵U, at least 15% up to 20% enriched ²³⁵U, at least 15.5% up to 20% enriched ²³⁵U, at least 16% up to 20% enriched ²³⁵U, at least 16.5% up to 20% enriched ²³⁵U, at least 17% up to 20% enriched ²³⁵U, at least 17.5% up to 20% enriched ²³⁵U, at least 18% up to 20% enriched ²³⁵U, at least 18.5% up to 20% enriched ²³⁵U, at least 19% up to 20% enriched ²³⁵U, and at least 19.5% up to 20% enriched ²³⁵U.

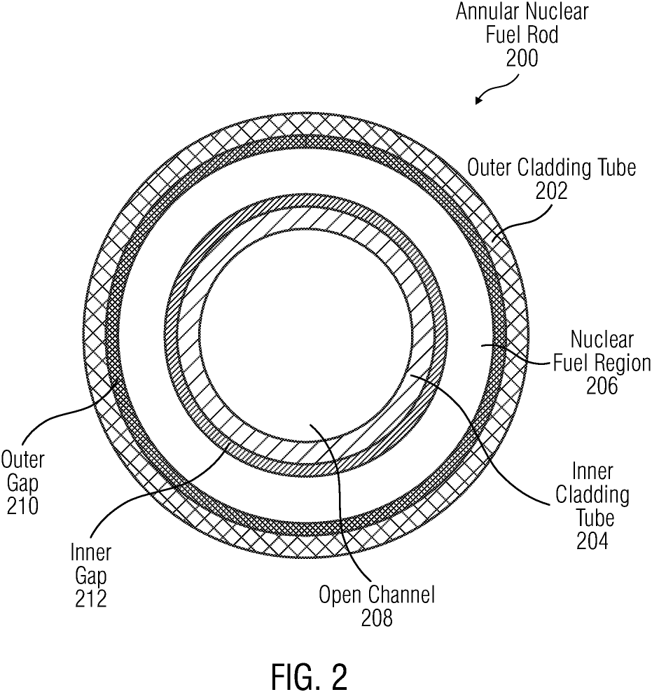

In various embodiments, the annular nuclear fuel rod disclosed herein can further comprise an outer gap 210, from 50 microns to 2 mm, located between the outer cladding tube 202 and the nuclear fuel region 206. In various embodiments, the annular nuclear fuel rod disclosed herein can further comprise an inner gap 212, from 50 microns to 2 mm, located between the inner cladding tube 204 and the nuclear fuel region 206. In other embodiments, the annular nuclear fuel rod disclosed herein can further comprise an outer gap 210 located between the outer cladding tube 202 and the nuclear fuel region 206 and an inner gap 212 located between the inner cladding tube 204 and the nuclear fuel region 206, as illustrated in FIG. 2. The gap (i.e., an outer gap and/or inner gap) positioned between the fuel pellet and the outer/inner cladding tube can prevent cracking of ceramic or cermet cladding tubes and thereby maintain hermeticity by avoiding hard contact between the pellet and cladding due to the swelling of the pellet during use.

In various embodiments, liquid metal or alloy (i.e., liquid metal bonding) with a low melting point and relatively high boiling point, such as Na, K, Pb, Sn, Bi, Ga, and mixtures thereof, can be included in the outer gap 210 located between the outer cladding tube 202 and the nuclear fuel region 206. In various embodiments, liquid metal or alloy can be included in the inner gap 212 located between the inner cladding tube 204 and the nuclear fuel region 206. Liquid metal bonding can increase the thermal conductivity of the nuclear fuel pellet-cladding gap, allow for increased fuel swelling due to a larger gap size, and may act to impede coolant incursion into the fuel rod in event of a leak through a crack or hole in the cladding thereby helping to retain fission products and reduce fuel coolant interactions and corrosion.

Packed uranium fuel particles (i.e., UO₂, UN, UB₂, UB₄, or UC) with liquid metal bonding, metal, and cermet fuels can decrease peak fuel temperatures, thereby allowing for higher heat volumetric generation rates and higher heat fluxes from fuel to coolant when core-averaged.

In various embodiments, the outer cladding tube, nuclear fuel region, and inner cladding tube can be enclosed by a top end plug and a bottom end plug. The top end plug can be a SiC (or ceramic or composite plug matching the main cladding material) annular end plug or metallic annular end plug. The bottom end plug can be a SiC annular end plug (or ceramic or composite plug matching the main cladding material) or metallic annular end plug. In certain embodiments, the SiC annular end plugs can be attached to the outer cladding tube, nuclear fuel region, and inner cladding tube using ceramic brazing. In certain embodiments, the metallic annular end plugs can be attached to the outer cladding tube, nuclear fuel region, and inner cladding tube using metallic brazing. In certain embodiments, the top end plug and bottom end plug can be attached to the outer cladding tube, nuclear fuel region, and inner cladding tube using mechanical interlocking methods. The top end plug and bottom end plug can be attached to the outer cladding tube, nuclear fuel region, and inner cladding tube using mechanical interlocking methods, ceramic brazing, metallic brazing, or combinations thereof.

The annular fuel rods disclosed herein can provide an extremely power dense core and due to the high ²³⁵U content can achieve >65 gigawatt-days per metric ton of uranium (GWD/MTU) burnup, >70 GWD/MTU burnup, >75 GWD/MTU burnup, >80 GWD/MTU burnup, >85 GWD/MTU burnup, >90 GWD/MTU burnup, >95 GWD/MTU burnup, or >100 GWD/MTU burnup.

The annular fuel rods disclosed herein can be used in light water reactors (LWRs), heavy water reactors (HWRs), lead fast reactors (LFRs), sodium fast reactors, molten salt reactors, and gas cooled reactors.

Various aspects of the subject matter described herein are set out in the following examples.

Example 1 - An annular nuclear fuel rod comprising an outer cladding tube made of ceramic composite or cermet composite; an inner cladding tube made of ceramic composite or cermet composite; a nuclear fuel region located between the outer cladding tube and inner cladding tube; and an open channel for liquid coolant to flow, wherein the open channel extends through the inner cladding tube.

Example 2 - The annular nuclear fuel rod of Example 1, wherein the ceramic composite comprises silicon carbide (SiC), aluminum oxide (Al₂O₃), boron carbide (BC), boron nitride (BN), carbon fiber (C), other ultra-high temperature ceramic matrix composites (UHTCMCs), technical ceramics such as: SiO₂, SiN, ZrO₂, SiAlON type ceramics, ZrB₂, HfB₂, TaSi₂, Si₃N₄, MoSi₂, ZrSi₂, (Hf, Zr, Ta)C, or combinations thereof.

Example 3 - The annular nuclear fuel rod of any one of Examples 1 or 2, wherein the cermet composite comprises a metal; and one or more of SiC, Al₂O₃, BC, BN, C, UHTCMCs, technical ceramics such as: SiO₂, SiN, ZrO₂, SiAlON type ceramics, ZrB₂, HfB₂, TaSi₂, Si₃N₄, MoSi₂, ZrSi₂, (Hf, Zr, Ta)C, or combinations thereof.

Example 4 - The annular nuclear fuel rod of any one of Examples 1-3, wherein the nuclear fuel region comprises nuclear fuel in annular pellet form.

Example 5 - The annular nuclear fuel rod of Example 4, wherein the nuclear fuel in annular pellet form is selected from a group consisting of uranium dioxide (UO₂), uranium nitride (UN), uranium diboride (UB₂), uranium tetraboride (UB₄), and uranium carbide (UC), and wherein the nuclear fuel is alone, in combination with another nuclear fuel, or in combination with an additive selected from the group consisting of Zr, Cr, Mo, ZrB₂, Cr₂O₃, Al₂O₃, and combinations thereof.

Example 6 - The annular nuclear fuel rod of any one of Examples 4 or 5, wherein the nuclear fuel in annular pellet form comprises greater than 5% enriched ²³⁵U.

Example 7 - The annular nuclear fuel rod of any one of Examples 4 or 5, wherein the nuclear fuel in annular pellet form comprises at least 6% enriched ²³⁵U.

Example 8 - The annular nuclear fuel rod of any one of Examples 1-7, further comprising: an outer gap located between the outer cladding tube and the nuclear fuel region; and an inner gap located between the inner cladding tube and the nuclear fuel region.

Example 9 - The annular nuclear fuel rod of any one of Examples 1-8, wherein the outer cladding tube, nuclear fuel region, and inner cladding tube are enclosed by a top end plug and a bottom end plug.

Example 10 - The annular nuclear fuel rod of Example 9, wherein the top end plug and bottom end plug are SiC annular end plugs or metallic annular end plugs.

Example 11 - The annular nuclear fuel rod of Example 10, wherein the SiC annular end plugs are attached to the outer cladding tube, nuclear fuel region, and inner cladding tube using ceramic brazing.

Example 12 - The annular nuclear fuel rod of Example 10, wherein the metallic annular end plugs are attached to the outer cladding tube, nuclear fuel region, and inner cladding tube using metallic brazing.

Example 13 - The annular nuclear fuel rod of any one of Examples 8-12, further comprising liquid metal in the outer gap located between the outer cladding tube and the nuclear fuel region.

Example 14 - The annular nuclear fuel rod of any one of Examples 8-12, further comprising liquid metal in the inner gap located between the inner cladding tube and the nuclear fuel region.

Example 15 - The annular nuclear fuel rod of any one of Examples 9-14, wherein the top end plug and bottom end plug are attached to the outer cladding tube, nuclear fuel region, and inner cladding tube using mechanical interlocking methods.

Example 16 - The annular nuclear fuel rod of any one of Examples 9-14, wherein the top end plug and bottom end plug are attached to the outer cladding tube, nuclear fuel region, and inner cladding tube using mechanical interlocking methods, ceramic brazing, metallic brazing, or combinations thereof.

Example 17 - The annular nuclear fuel rod of any one of Examples 1-16, wherein the annular fuel rod is used in reactors selected from the group consisting of: light water reactors (LWRs), heavy water reactors (HWRs), lead fast reactors (LFRs), sodium fast reactors, molten salt reactors, and gas cooled reactors.

Example 18 - An annular nuclear fuel rod comprising an outer cladding tube made of ceramic composite or cermet composite; an inner cladding tube made of ceramic composite or cermet composite; a nuclear fuel region located between the outer cladding tube and inner cladding tube, wherein the nuclear fuel region comprises a nuclear cermet fuel in annular pellet form; an open channel for liquid coolant to flow, wherein the open channel extends through the inner cladding tube.

Example 19 - The annular nuclear fuel rod of Example 18, wherein the nuclear cermet fuel in annular pellet form comprises: an inert metal matrix; and UO₂, UN, UB₂, UB₄, or UC wherein the UO₂, UN, UB₂, UB₄, or UC is alone, in combination, or in combination with an additive selected from the group consisting of Zr, Cr, Mo, ZrB₂, Cr₂O₃, Al₂O₃, and combinations thereof.

Example 20 - The annular nuclear fuel rod of Example 18, wherein the nuclear cermet fuel in annular pellet form comprises greater than 5% enriched ²³⁵U.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The term “substantially”, “about”, or “approximately” as used in the present disclosure, unless otherwise specified, means an acceptable error for a particular value as determined by one of ordinary skill in the art, which depends in part on how the value is measured or determined. In certain embodiments, the term “substantially”, “about”, or “approximately” means within 1, 2, 3, or 4 standard deviations. In certain embodiments, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. An annular nuclear fuel rod comprising:
an outer cladding tube made of ceramic composite or cermet composite;
an inner cladding tube made of ceramic composite or cermet composite;
a nuclear fuel region located between the outer cladding tube and inner cladding tube; and
an open channel for liquid coolant to flow, wherein the open channel extends through the inner cladding tube.

2. The annular nuclear fuel rod of claim 1, wherein the ceramic composite comprises silicon carbide (SiC), aluminum oxide (Al₂O₃), boron carbide (BC), boron nitride (BN), carbon fiber (C), other ultra-high temperature ceramic matrix composites (UHTCMCs), technical ceramics such as: SiO₂, SiN, ZrO₂, SiAlON type ceramics, ZrB₂, HfB₂, TaSi₂, Si₃N₄, MoSi₂, ZrSi₂, (Hf, Zr, Ta)C, or combinations thereof.

3. The annular nuclear fuel rod of claim 1, wherein the cermet composite comprises:
a metal; and
one or more of SiC, Al₂O₃, BC, BN, C, UHTCMCs, technical ceramics such as: SiO₂, SiN, ZrO₂, SiAlON type ceramics, ZrB₂, HfB₂, TaSi₂, Si₃N₄, MoSi₂, ZrSi₂, (Hf, Zr, Ta)C, or combinations thereof.

4. The annular nuclear fuel rod of claim 1, wherein the nuclear fuel region comprises nuclear fuel in annular pellet form.

5. The annular nuclear fuel rod of claim 4, wherein the nuclear fuel in annular pellet form is selected from a group consisting of uranium dioxide (UO₂), uranium nitride (UN), uranium diboride (UB₂), uranium tetraboride (UB₄), and uranium carbide (UC), and wherein the nuclear fuel is alone, in combination with another nuclear fuel, or in combination with an additive selected from the group consisting of Zr, Cr, Mo, ZrB₂, Cr₂O₃, Al₂O₃, and combinations thereof.

6. The annular nuclear fuel rod of claim 4, wherein the nuclear fuel in annular pellet form comprises greater than 5% enriched ²³⁵U.

7. The annular nuclear fuel rod of claim 4, wherein the nuclear fuel in annular pellet form comprises at least 6% enriched ²³⁵U.

8. The annular nuclear fuel rod of claim 1, further comprising:
an outer gap located between the outer cladding tube and the nuclear fuel region; and
an inner gap located between the inner cladding tube and the nuclear fuel region.

9. The annular nuclear fuel rod of claim 1, wherein the outer cladding tube, nuclear fuel region, and inner cladding tube are enclosed by a top end plug and a bottom end plug.

10. The annular nuclear fuel rod of claim 9, wherein the top end plug and bottom end plug are SiC annular end plugs or metallic annular end plugs.

11. The annular nuclear fuel rod of claim 10, wherein the SiC annular end plugs are attached to the outer cladding tube, nuclear fuel region, and inner cladding tube using ceramic brazing.

12. The annular nuclear fuel rod of claim 10, wherein the metallic annular end plugs are attached to the outer cladding tube, nuclear fuel region, and inner cladding tube using metallic brazing.

13. The annular nuclear fuel rod of claim 8, further comprising liquid metal in the outer gap located between the outer cladding tube and the nuclear fuel region.

14. The annular nuclear fuel rod of claim 8, further comprising liquid metal in the inner gap located between the inner cladding tube and the nuclear fuel region.

15. The annular nuclear fuel rod of claim 9, wherein the top end plug and bottom end plug are attached to the outer cladding tube, nuclear fuel region, and inner cladding tube using mechanical interlocking methods.

16. The annular nuclear fuel rod of claim 9, wherein the top end plug and bottom end plug are attached to the outer cladding tube, nuclear fuel region, and inner cladding tube using mechanical interlocking methods, ceramic brazing, metallic brazing, or combinations thereof.

17. The annular nuclear fuel rod of claim 1, wherein the annular fuel rod is used in reactors selected from the group consisting of: light water reactors (LWRs), heavy water reactors (HWRs), lead fast reactors (LFRs), sodium fast reactors, molten salt reactors, and gas cooled reactors.

18. An annular nuclear fuel rod comprising:
an outer cladding tube made of ceramic composite or cermet composite;
an inner cladding tube made of ceramic composite or cermet composite;
a nuclear fuel region located between the outer cladding tube and inner cladding tube, wherein the nuclear fuel region comprises a nuclear cermet fuel in annular pellet form;
an open channel for liquid coolant to flow, wherein the open channel extends through the inner cladding tube.

19. The annular nuclear fuel rod of claim 18, wherein the nuclear cermet fuel in annular pellet form comprises:
an inert metal matrix; and
UO₂, UN, UB₂, UB₄, or UC wherein the UO₂, UN, UB₂, UB₄, or UC is alone, in combination, or in combination with an additive selected from the group consisting of Zr, Cr, Mo, ZrB2, Cr₂03, AI2O₃, and combinations thereof.

20. The annular nuclear fuel rod of claim 18, wherein the nuclear cermet fuel in annular pellet form comprises greater than 5% enriched ²³⁵U.
